(19) United States
(12) Patent Application Publication
(10) Pub. No.: US 2008/0177918 A1
(43) Pub. Date: Jul. 24, 2008

(54) METHOD AND APPARATUS FOR CONTROLLING TIMING OF STATE TRANSITION OF SERIAL DATA LINE IN 12C CONTROLLER

(75) Inventors: Dong-soo LEE, Suwon-si (KR); Ki-mo KIM, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/767,546

(22) Filed: Jun. 25, 2007

(30) Foreign Application Priority Data
Jan. 23, 2007 (KR) 10-2007-0007240

(51) Int. Cl. G06F 13/00

(52) U.S. Cl. 710/110

(57) ABSTRACT

A method and apparatus for controlling the timing of a state transition of a serial data line (SDA) in an I2C controller are provided. The apparatus includes a processor, a serial clock line (SCL) edge detector, a counter, and an SDA generator. The processor controls an I2C controller. The SCL edge detector detects an edge of a clock signal of an SCL. The counter counts a hold time of the state transition of the SDA if a falling edge of the clock signal of the SCL is detected by the SCL edge detector. The SDA generator transits the state of the SDA if the count of the hold time is finished. Therefore, a malfunction in an I2C communication can be prevented without using a compensation circuit requiring a lot of time and cost.

### CROSS-REFERENCE TO RELATED PATENT APPLICATION

This application claims priority from Korean Patent Application No. 10-2007-0007240, filed on Jan. 23, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to an Intelligent Interface Controller (I2C), and more particularly, to a method and apparatus for controlling the timing of a state transition of a serial data line (SDA) in an I2C controller.

2. Description of the Related Art

An I2C bus is a standard bidirectional serial bus that provides a communication link between peripheral devices by connecting the peripheral devices using only two signal lines. The I2C bus includes a serial clock line (SCL) and a serial data line (SDA). The I2C bus is currently an actual standard solution for built-in devices.

FIG. 1 illustrates a basic protocol of an I2C bus.

Referring to FIG. 1, serial data, transferred through an SDA, is formatted to include 9-bit data that contains a 1-bit ACKnowledgement (ACK) and 8-bit data.

A master generates a clock signal for data transmission. A start signal and an end signal are used to indicate the start and the end of the data transmission. When the master receives an ACK signal for each 8-bit data transmission from a slave device, it determines that the data transmission is successful. A restart can be used when it is required to transmit data again before the end of the data transmission.

When the master initiates a START condition, slave devices connected to the I2C bus wait for subsequent data. In the START condition, a state in which both an SCL and the SDA are high transits into a state in which the SCL is high and the SDA is low.

When all operations are ended, the master initiates a STOP condition. In the STOP condition, the SDA transits from low to high while the SCL is high.

In actual data transmission, a state transition of data must occur only in a period when the SCL is low, and an SDA signal can be sampled anytime in a period when the SCL is high. At this point, the data is 8-bit data and a most significant bit (MSB) is first transmitted.

FIGS. 2A and 2B illustrate a circuit in which a master and a slave are connected using the I2C bus.

Referring to FIGS. 2A and 2B, an SDA signal and an SCL signal associated with the I2C bus are first generated in digital form inside devices. However, these signals are distorted due to a pull-up resistor, a serial resistor, wire capacitance, and cross channel capacitance during transmission. The distortion is mainly caused by parasitic resistance and parasitic capacitance generated in each device or in a circuit board.

Accordingly, various problems arise. For example, a state transition time of transmitted data increases excessively, and a signal voltage is not enough to be treated as a digital signal because electric charges are not charged and discharged sufficiently.

FIG. 3 is a timing diagram illustrating a case where a state transition of an SCL occurs later than a state transition of an SDA when a falling time of a clock signal of the SCL increases due to the presence of a large RC component in the SCL.

Referring to FIG. 3, it is interpreted as though the SDA transits from high to low in a period when the SCL is high, and an I2C controller can recognize this as the generation of a restart signal.

In a period that transmits 8-bit data and 1-bit ACK, if the transmitted data is recognized as the start or end signal of data transmission, the I2C controller and peripheral devices fail to satisfy the timing standards of the I2C and thus malfunction or fall into a wrong state.

Additionally, it is very difficult to precisely predict parasitic components of actual devices. Moreover, the above problems generally occur after a circuit board is completely configured. The use of a compensation circuit or the replacement of the devices is possible, but these methods require a lot of time and cost.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for controlling the timing of a state transition of a serial data line (SDA) in an I2C controller to prevent the malfunction in an I2C communication by controlling the timing of the state transition of the SDA in the I2C controller without using a compensation circuit which requires a lot of time and cost.

According to an aspect of the present invention, there is provided an apparatus for controlling the timing of a state transition of a serial data line (SDA), including: a serial clock line (SCL) edge detector which detects an edge of a clock signal of an SCL; a counter which counts a hold time of the state transition of the SDA when a falling edge of the clock signal of the SCL is detected by the SCL edge detector; an SDA generator which transits the state of the SDA if the count of the hold time is finished; and a processor which interfaces the SCL edge detector, the counter, and the SDA generator.

The apparatus may further include an I2C slave interface which sets a hold time of the counter by receiving a hold time from a central processing unit (CPU).

The processor may determine if the state transition of the SDA is for the purpose of transmitting a start or end signal of data transmission, or for the purpose of actual data transmission.

The SDA generator may transit the state of the SDA without counting the hold time if the state transition of the SDA is for the purpose of transmitting the start or end signal of the data transmission.

The counter may count in synchronization with a system clock signal received from outside of the I2C controller.

The counter may perform down-counting from the hold time to 0.

The counter may initialize the hold time if a rising edge of the clock signal is detected by the SCL edge detector.

The I2C slave interface may include a register for hold time enable setting.

The counter may be set to a different hold time according to the transmission speed of a slave device.

The hold time may be smaller than a time interval between a rising edge of the clock signal and the state transition of the SDA.

According to another aspect of the present invention, there is provided a method of controlling the timing of a state transition of a serial data line (SDA) in an I2C controller, including: detecting a falling edge of a clock signal of a serial clock line (SCL); counting a hold time of the state transition of the SDA if the falling edge is detected; and transiting the state of the SDA if the count of the hold time is finished.

According to another aspect of the present invention, there is provided a computer-readable recording medium storing a program for executing the method of controlling the timing of a state transition of a serial data line (SDA) in an I2C controller, including: detecting a falling edge of a clock signal of a serial clock line (SCL); counting a hold time of the state transition of the SDA if the falling edge is detected; and transiting the state of the SDA if the count of the hold time is finished.

### BRIEF DESCRIPTION OF THE DRAWINGS

The above and other aspects of the present invention will become more apparent by describing in detail exemplary embodiments thereof with reference to the attached drawings in which:

FIG. 1 illustrates a basic protocol of an I2C bus;

FIGS. 2A and 2B illustrate a circuit in which a master and a slave are connected using an I2C;

FIG. 3 is a timing diagram illustrating a case where a state transition of a serial clock line (SCL) occurs later than a state transition of a serial data line (SDA), when a falling time of a clock signal of the SCL increases due to the presence of a large RC component in the SCL;

FIGS. 4A and 4B are block diagrams illustrating apparatuses for controlling the timing of a state transition of an SDA according to exemplary embodiments of the present invention;

FIG. 5 is a timing diagram illustrating a case where a state transition of an SDA is delayed during a hold time after a falling edge of a clock signal of an SCL according to an exemplary embodiment of the present invention;

FIG. 6 is a timing diagram illustrating a timing at which a counter is initialized after a rising edge of a clock signal of an SCL according to an exemplary embodiment of the present invention;

FIG. 7 is a flowchart illustrating a method of controlling the timing of a state transition of an SDA according to an exemplary embodiment of the present invention;

FIG. 8 is a flowchart illustrating a method of controlling the timing of a state transition of an SDA according to another exemplary embodiment of the present invention;

FIG. 9 is a flowchart illustrating a method of controlling the timing of a state transition of an SDA according to another exemplary embodiment of the present invention; and

FIG. 10 is a flowchart illustrating a method of controlling the timing of a state transition of an SDA according to another exemplary embodiment of the present invention.

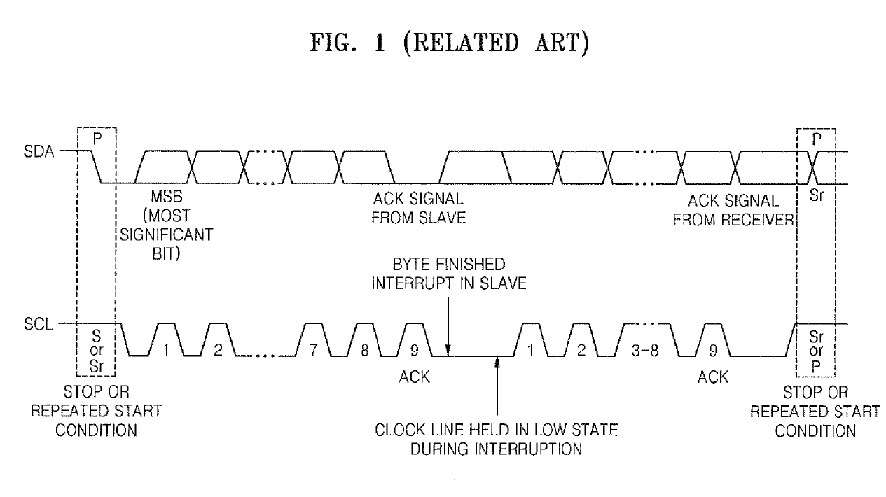

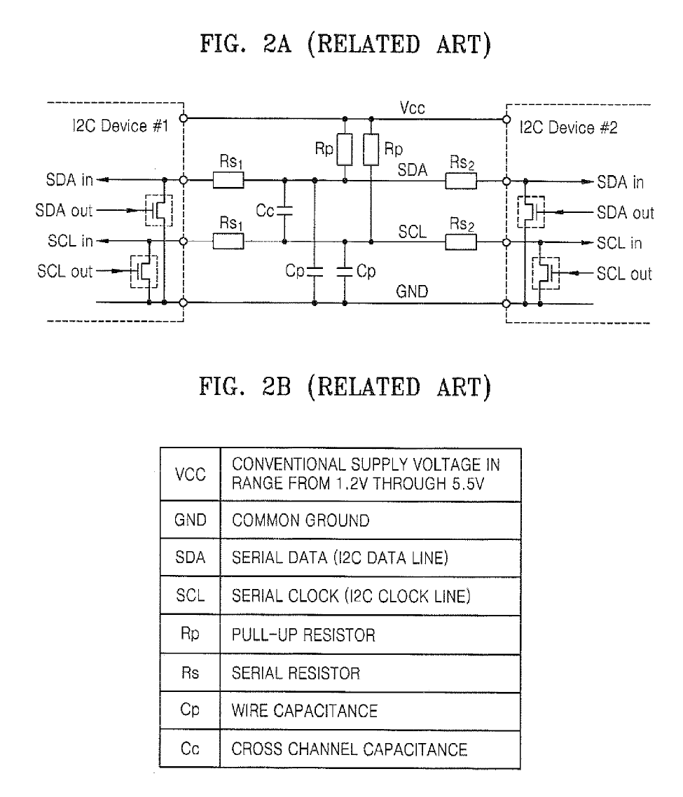

### DETAILED DESCRIPTION OF THE INVENTION

The present invention will now be described more fully with reference to the accompanying drawings, in which exemplary embodiments of the invention are shown.

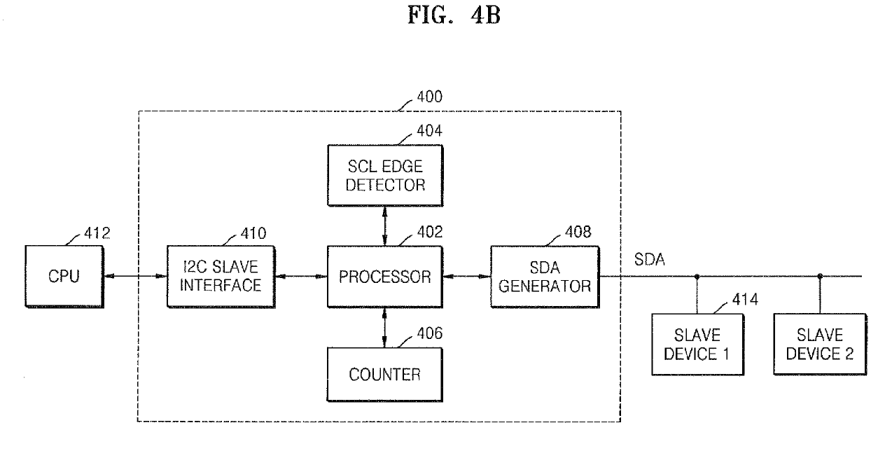

FIG. 4A is a block diagram illustrating an apparatus for controlling the timing of a state transition of a serial data line (SDA) according to an exemplary embodiment of the present invention.

Referring to FIG. 4A, an apparatus 400 for controlling the timing of a state transition of the SDA according to an exemplary embodiment of the present invention includes a processor 402, a serial clock line (SCL) edge detector 404, a counter 406, and an SDA generator 408.

The processor 402 is a main controller of an I2C controller, controls the I2C controller's functions (e.g., protocol control and related interrupt control), and interfaces other components.

The SCL edge detector 404 detects a rising edge and a falling edge of a clock signal of an SCL, and transmits detection signals to the processor 402. The clock signal of the SCL is generated by an SCL generator (not shown).

When actual data, not a start or end signal of data transmission, is transmitted, in a case when the SCL edge detector 404 detects the falling edge of the clock signal of the SCL, the state transition of the SDA is possible (because the SCL is low). The processor 402 determines if the state transition of the SDA is for the purpose of transmitting the start or end signal of the data transmission, or for the purpose of transmitting actual data.

The counter 406 counts a hold time of the state transition of the SDA when the falling edge of the clock signal of the SCL is detected by the SCL edge detector 404. The hold time indicates a delay time between the time when the falling edge of the clock signal of the SCL occurs and the time when the state transition of the SDA occurs.

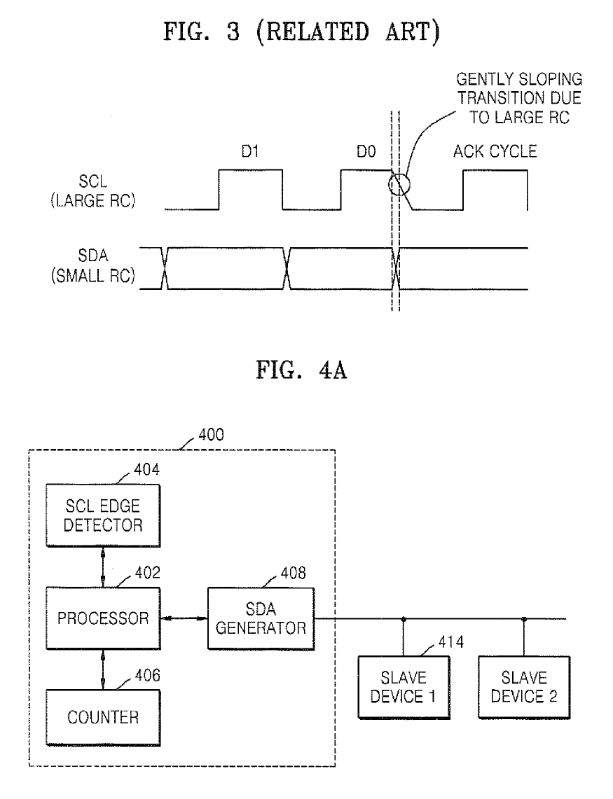

As illustrated in FIG. 3, the hold time is needed for preventing slave devices 414 from recognizing that a state transition of the SCL occurs later than the state transition of the SDA when a falling time of the clock signal of the SCL increases due to a large RC component of the SCL.

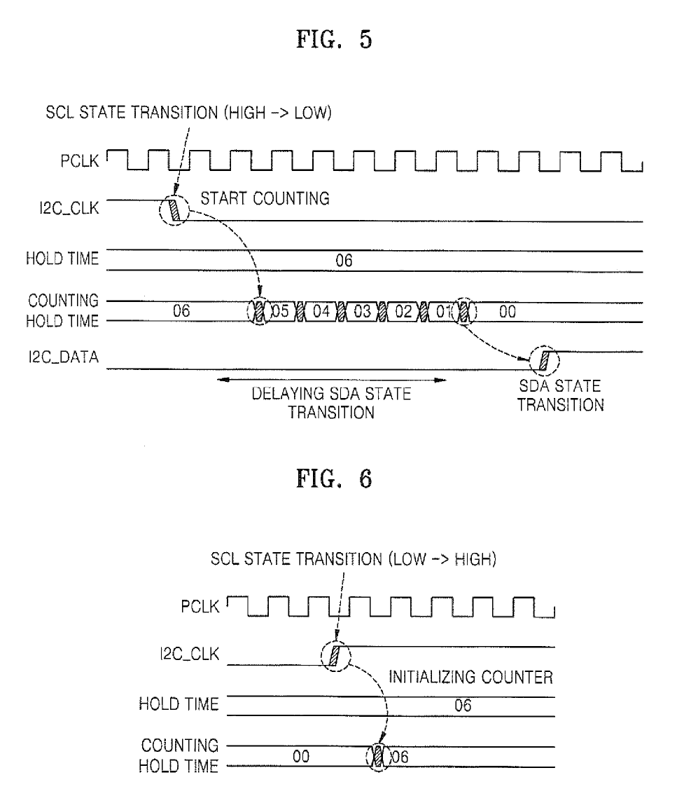

The hold time is counted by the counter 46 in synchronization with a system clock signal (i.e., PCLK in FIGS. 5 and 6) received from outside of the I2C controller. Accordingly, when the falling edge of the clock signal of the SCL occurs, the hold time is counted in synchronization with a PCLK. When the count of the hold time is finished, the counter 406 reports this to the SDA generator 408. The SDA generator 408 changes an SDA state.

The processor 402 initializes the hold time of the counter 406 when the rising edge of the clock signal of the SCL is detected by the SCL edge detector 404.

The SDA generator 408 records data to and reads data from the slave devices 414 according to the clock signal of the SCL. The SDA generator 408 changes the SDA state when the counter 406 finishes the count of the hold time.

However, when the state transition of the SDA is for the purpose of transmitting the start or end signal of the data transmission, the SDA generator 408 changes the state of the SDA without counting the hold time. It is because a timing margin, which is required for a start or end of the data transmission, may be reduced if the state transition of the SDA is delayed at the time when the start or end signal of the data transmission is generated.

Therefore, the processor 402 determines if the state transition of the SDA is for the purpose of transmitting the start or end signal of the data transmission, or for the purpose of transmitting actual data, and counts the hold time only when transmitting actual data.

The apparatus 400 for controlling the timing of the state transition of the SDA may be included inside a system-on-chip.

FIG. 4B is a block diagram illustrating an apparatus for controlling the timing of a state transition of an SDA according to another exemplary embodiment of the present invention.

Referring to FIG. 4B, the apparatus 400 for controlling the timing of the state transition of the SDA according to another exemplary embodiment of the present invention includes a processor 402, an SCL edge detector 404, a counter 406, an SDA generator 408 and an I2C slave interface 410.

The processor 402, the SCL edge detector 404, the counter 406 and the SDA generator 408 in FIG. 4B are equal to their counterparts in FIG. 4A, and thus a detailed description thereof will be omitted for conciseness.

The I2C slave interface 410 interfaces with a central processing unit (CPU) 412. The I2C slave interface 410 can allow a hold time of the counter 406 to be set by receiving the hold time from the CPU 412 and storing the hold time.

The I2C slave interface 410 may include a register for hold time enable setting so as to turn on/off a delay function which is achieved by counting the hold time.

The CPU 412 controls the I2C slave interface 410 to set the hold time of the counter 406. The hold time of the counter 406 can be set differently according to the transmission speed of slave devices.

The hold time is desired to be smaller than a time interval between a rising edge of a clock signal of the SCL and a state transition of the SDA. A hold time, which is a time interval between a falling edge of a clock signal of the SCL and a state transition of the SDA, is generally small, but a setup time, which is a time interval between a rising edge of a clock signal of the SCL and a state transition of the SDA, requires a relatively large timing margin.

FIG. 5 is a timing diagram illustrating a case where a state transition of an SDA is delayed during a hold time after a falling edge of a clock signal of an SCL according to an exemplary embodiment of the present invention.

Referring to FIG. 5, the hold time in the present exemplary embodiment is set to 6. A PCLK is a system clock signal received from the outside of an I2C controller. An I2C_CLK is the clock signal of the SCL for transmitting SDA data. I2C_DATA is data that is transmitted through the SDA.

While the I2C_DATA is low, a counter 406 starts to count the hold time when the I2C_CLK changes from high to low. In the present exemplary embodiment, the counter 406 performs down counting from the hold time to 0.

After the down counting is finished, the state of the I2C_DATA is changed by an SDA generator 408. Although the state transition of the I2C_DATA is delayed during the hold time, the operation of a total system is not affected because the frequency of the PCLK is actually much higher than the frequency of the I2C_CLK. Also, a malfunction in an I2C communication may be prevented by the delay of the state transition.

FIG. 6 is a timing diagram illustrating a timing at which a counter is initialized after a rising edge of a clock signal of an SCL according to an exemplary embodiment of the present invention.

Referring to FIG. 6, a hold time is set to 6, the counter 405 performs down-counting from the hold time to 0.

In a period when actual data is transmitted, a stage change of an SDA does not occur after the rising edge of the clock signal of the SCL occurs. Accordingly, if the rising edge of the clock signal of the SCL is detected by an SCL edge detector 404, the value of a count is initialized according to a predetermined hold time.

After the I2C transmission speed to slave devices 414 is determined and all circuits associated with the I2C are configured, the hold time may be set by measuring the timing of an I2C analog signal acquired from observing the configured circuits.

An I2C slave interface 410 may include a register for hold time enable setting. The register makes it possible to turn on/off the hold time setting.

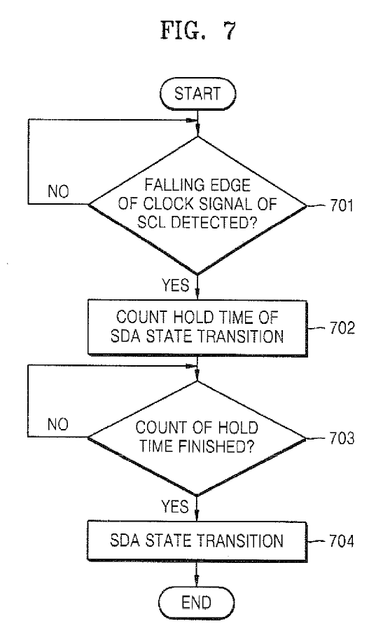

FIG. 7 is a flowchart illustrating a method of controlling the timing of a state transition of an SDA according to an exemplary embodiment of the present invention.

Referring to FIG. 7, in operation 701, an I2C controller detects a falling edge of a clock signal of an SCL. When actual data, not a start or end signal of data transmission, is transmitted state transition of the SDA is possible in a case when the falling edge of the clock signal of the SCL is detected and the data of the SCL is low.

In operation 702, a hold time of the state transition of the SDA is counted when the falling edge of the clock signal of the SCL is detected. The hold time is counted in synchronization with a system clock signal (i.e., PCLK in FIGS. 5 and 6) received from outside of the I2C controller. Therefore, the hold time is counted corresponding to the PCLK if the falling edge of the clock signal of the SCL occurs.

In operation 703, the I2C controller determines if the count of the hold time is finished. In operation 704, the I2C controller changes the state of the SDA when the count is finished.

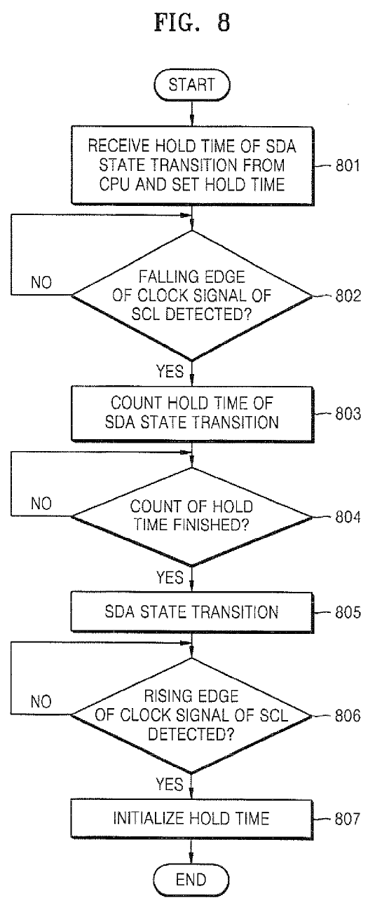

FIG. 8 is a flowchart illustrating a method of controlling the timing of a state transition of an SDA according to another exemplary embodiment of the present invention.

Referring to FIG. 8, in operation 801, an I2C controller establishes a hold time by receiving a hold time of a state transition of an SDA from a CPU 412. For example, the hold time may be received from the CPU 412 via an I2C slave interface 410.

Operations 802 through 805 in FIG. 8 correspond respectively to operations 701 through 704 in FIG. 7, and thus a detailed description thereof will be omitted for conciseness.

In operation 806, the I2C controller detects a rising edge of a clock signal of an SCL. In operation 807, the I2C controller initializes the hold time when the rising edge of the clock signal of the SCL is detected. In a period when actual data, not a start or end signal of data transmission, is transmitted, the state transition of the SDA does not occur after the rising edge of the clock signal of the SCL occurs. Accordingly, the I2C controller initializes the hold time (i.e., count value) at that time.

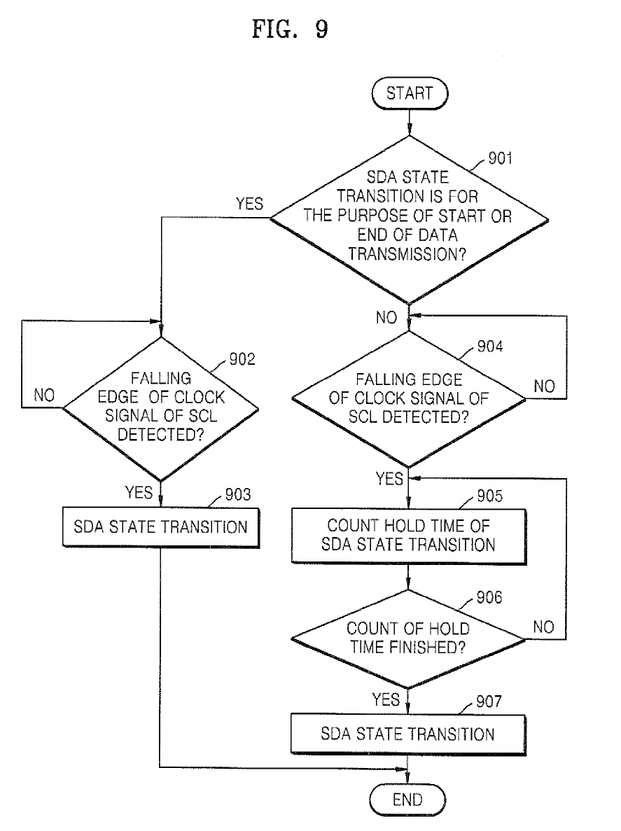

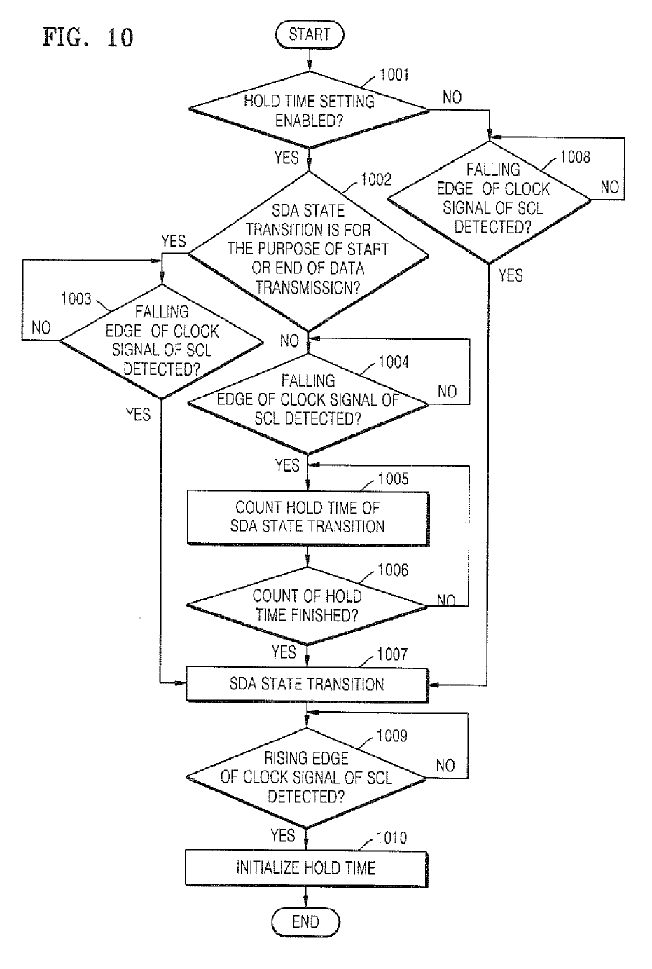

FIG. 9 is a flowchart illustrating a method of controlling the timing of a state transition of an SDA according to another exemplary embodiment of the present invention.

Referring to FIG. 9, in operation 901, an I2C controller determines if a state transition of the SDA is for the purpose of transmitting a start or end signal of data transmission, or transmitting actual data. It is because a timing margin, which is required for transmitting the start or end signal of data transmission, is reduced if the state transition of the SDA is delayed at the time when the start or end signal of the data transmission occurs.

When the state transition of the SDA is for the purpose of transmitting the start or end signal of the data transmission, the state of the SDA is changed without counting the hold time in operation 903 after the falling edge of the clock signal of the SCL is detected in operation 902.

However, if the state transition of the SDA is for the purpose of transmitting actual data, the I2C controller counts the hold time and changes the state of the SDA in operations 904 through 907. Operations 904 through 907 in FIG. 9 correspond respectively to operations 701 through 704 in FIG. 7, and thus a detailed description thereof will be omitted for conciseness.

FIG. 10 is a flowchart illustrating a method of controlling the timing of a state transition of an SDA according to another exemplary embodiment of the present invention.

Referring to FIG. 10, in operation 1001, an I2C controller determines if hold time enable setting is set. The determining operation of the I2C controller is provided for the purpose of permitting users to freely determine the adoption of the hold time enable setting because users may not want to use the hold time enable setting.

If the hold time enable setting is set, in operation 1002, the I2C controller determines if the state transition of the SDA is for the purpose of transmitting a start or end signal of data transmission, or transmitting actual data. Operations 1003 through 1007 in FIG. 10 correspond respectively to operations 902 through 907 in FIG. 9, and thus a detailed description thereof will be omitted for conciseness.

However, if the hold time enable setting is not set, the state of the SDA is changed without counting the hold time in operation 1007 after a falling edge of a clock signal of an SCL is detected in operation 1008.

In operation 1009, the I2C controller detects a rising edge of a clock signal of the SCL. In operation 1010, the I2C controller initializes the hold time if the rising edge of the clock signal of the SCL is detected.

The invention can also be embodied as computer-readable codes on a computer-readable recording medium. The computer-readable recording medium is any data storage device that can store data, which can be thereafter read by a computer system.

Examples of the computer-readable recording medium include read-only memory (ROM), random-access memory (RAM), CD-ROMs, magnetic tapes, floppy disks, optical data storage devices, and carrier waves (such as data transmission through the Internet). The computer-readable recording medium can also be distributed over network-coupled computer systems so that the computer-readable code is stored and executed in a distributed fashion.

The apparatus for controlling the timing of a state transition of an SDA according to the present invention may be included in an I2C controller or a system-on-chip.

As described above, according to the apparatus and method of the present invention for controlling the timing of a state transition of an SDA in an I2C controller, the timing of the state transition of the SDA is controlled to be held for a predetermined time by a counter. Therefore, a malfunction in an I2C communication can be prevented without using a compensation circuit requiring a lot of time and cost.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus which controls the timing of a state transition of a serial data line (SDA), the apparatus comprising:
a serial clock line SCL edge detector which detects an edge of a clock signal of an SCL;
a counter which counts a hold time of the state transition of the SDA when a falling edge of the clock signal of the SCL is detected by the SCL edge detector;
an SDA generator which transits a state of the SDA if the count of the hold time is finished; and
a processor which interfaces the SCL edge detector, the counter, and the SDA generator.

2. The apparatus of claim 1, further comprising an Intelligent Interface Controller (I2C) slave interface which sets a hold time of the counter by receiving a hold time from a central processing unit (CPU).

3. The apparatus of claim 1, wherein the processor determines if the state transition of the SDA is for a purpose of transmitting a start signal of data transmission or an end signal of the data transmission, or for a purpose of actual data transmission.

4. The apparatus of claim 3, wherein the SDA generator changes the state of the SDA without counting the hold time if the state transition of the SDA is for the purpose of transmitting the start signal of the data transmission or the end signal of the data transmission.

5. The apparatus of claim 1, wherein the counter counts in synchronization with a system clock signal received from outside of the I2C controller.

6. The apparatus of claim 1, wherein the counter performs down-counting from the hold time to 0.

7. The apparatus of claim 1, wherein the counter initializes the hold time if a rising edge of the clock signal is detected by the SCL edge detector.

8. The apparatus of claim 2, wherein the I2C slave interface comprises a register for hold time enable setting.

9. The apparatus of claim 1, wherein the counter is set to a different hold time according to a transmission speed of a slave device.

10. The apparatus of claim 1, wherein the hold time is smaller than a time interval between a rising edge of the clock signal and the state transition of the SDA.

11. A method of controlling the timing of a state transition of a serial data line (SDA) in an I2C controller, the method comprising:
detecting a falling edge of a clock signal of a serial clock line (SCL);
counting a hold time of the state transition of the SDA if the falling edge of the clock signal of the SCL is detected; and
transmitting the state of the SDA if the count of the hold time is finished.

12. The method of claim 11, further comprising setting the hold time by receiving a hold time of the state transition of the SDA from a central processing unit (CPU).

13. The method of claim 11, further comprising determining if the state transition of the SDA is for a purpose of transmitting a start signal of data transmission or an end signal of the data transmission, or for a purpose of transmitting actual data.

14. The method of claim 13, further comprising changing the state of the SDA without counting the hold time if the state transition of the SDA is for the purpose of transmitting the start signal of the data transmission or the end signal of the data transmission.

15. The method of claim 11, wherein the counting of the hold time comprises counting in synchronization with a system clock signal received from outside of the I2C controller.

16. The method of claim 11, wherein the counting of the hold time comprises performing down counting from the hold time to 0.

17. The method of claim 11, further comprising:
detecting a rising edge of the clock signal of the SCL; and
initializing the hold time if the rising edge of the clock signal is detected.

18. The method of claim 11, further comprising determining if a hold time enable setting is set.

19. The method of claim 11, wherein the counting of the hold time comprises setting a hold time of the counter differently according to a transmission speed of a slave device.

20. The method of claim 11, wherein the hold time is smaller than a time interval between a rising edge of the clock signal and the state transition of the SDA.

21. A computer-readable recording medium storing a program for executing a method of controlling the timing of a state transition of a serial data line (SDA) in an I2C controller, the method comprising:
detecting a falling edge of a clock signal of a serial clock line (SCL);
counting a hold time of the state transition of the SDA if the falling edge of the clock signal of the SCL is detected; and
transmitting the state of the SDA if the count of the hold time is finished.

22. An I2C controller for controlling the timing of a state transition of a serial data line (SDA), the I2C controller comprising:
a serial clock line SCL edge detector which detects an edge of a clock signal of an SCL;
a counter which counts a hold time of the state transition of the SDA when a falling edge of the clock signal of the SCL is detected by the SCL edge detector;
an SDA generator which transits a state of the SDA if the count of the hold time is finished; and
a processor which interfaces the SCL edge detector, the counter, and the SDA generator.

23. A system-on-chip which controls the timing of a state transition of a serial data line (SDA), the system-on-chip comprising:
a serial clock line SCL edge detector which detects an edge of a clock signal of an SCL;
a counter which counts a hold time of the state transition of the SDA when a falling edge of the clock signal of the SCL is detected by the SCL edge detector;
an SDA generator which transits a state of the SDA if the count of the hold time is finished; and
a processor which interfaces the SCL edge detector, the counter, and the SDA generator.
